(19) United States
(12) Patent Application Publication
(10) Pub. No.: US 2002/0142217 A1
(43) Pub. Date: Oct. 3, 2002

(54) Germanium nitride electrode material for high capacity rechargeable lithium battery cell

(76) Inventors: Glenn G. Amatucci, Peapack, NJ (US); Nathalie Pereira, New York, NY (US)

Correspondence Address: David A. Hey, Esq., Telcordia Technologies, Inc., 445 South Street - Room 1G-112R, Morristown, NJ, 07960, US

(21) Appl. No.: 09/817,986

(22) Filed: Mar. 27, 2001

(51) Int. Cl. H01M 4/58; H01M 4/48

(52) U.S. Cl. 429/218.1; 429/231.1

(57) ABSTRACT

A high capacity rechargeable lithium battery cell comprising a positive electrode member, a negative electrode member, and an interposed separator member providing an electrolyte comprises a negative active electrode material consisting essentially of germanium nitride. The germanium nitride electrode material effectively replaces carbonaceous negative electrode materials, providing significantly improved stable gravimetric capacity of about 450 mAh/g and volumetric capacity exceeding that of graphite by more than an order of magnitude.

### BACKGROUND OF THE INVENTION

The present invention relates to rechargeable electrochemical energy storage systems, particularly such systems comprising complementary electrodes capable of reversibly intercalating, alloying, or otherwise alternately combining with and releasing lithium ions in electrical energy charge and discharge operations. The invention comprises, in its preferred embodiments, high capacity lithium battery cells comprising germanium nitride electrodes which provide exceptionally high, stable discharge capacity in such cells.

Early rechargeable lithium battery cells relied primarily on metallic lithium electrodes, but disadvantages associated with recharging of such cells, particularly the formation of dendrites which led to shorting within the cell, resulted, in addition to resident dangers, in limited useful cycle life of these cells. Lithium alloys with metals such as tin or aluminum showed some promise of improvement from the dangerous conditions attributed to pure lithium metal; however, the relatively large expansion fluctuations exhibited by these materials during cycling resulted in intraparticle damage which ultimately defeated initial cell capacity gains.

Carbonaceous negative electrode materials, such as petroleum coke, hard carbon, and graphite, have been widely investigated and are regularly employed in lithium cells, but these materials are limited in volumetric capacity and present other difficulties, such as their contributing to the instability and degradation of electrolyte compositions. Investigators have turned in part to employing lithiating negative electrodes comprising oxides of Sn, Si, Sb, Mg, and the like and have had some success in avoiding the drawbacks seen in carbons materials, but cycle life of these cells has lacked significant note.

Some specialized lithiation materials, such as oxides of non-alloying transition metals and the amorphous lithiated nitrides of transition metals, have also been investigated with varying success in capacity stability and cell voltage output. For example, the latter materials, described by Shodai et al. in U.S. Pat. No. 5,834,139, have reportedly exhibited good capacity and cycling stability; however, cell output voltage is significantly higher than desired in commercial implementations, and, of greater import, these active electrode materials are reactive in ambient atmosphere and require careful attention to controlled environment to enable practical use.

### SUMMARY OF THE INVENTION

In the present invention it has been discovered that an active negative electrode material of germanium nitride, typically Ge₃N₄, provides in combination with an active positive electrode material source of lithium ions and an intervening electrically insulative, ion-conductive separator incorporating a typical non-aqueous electrolyte composition a rechargeable lithium battery cell exhibiting superlative cycling stability and exceptionally high capacity. Particularly when compared with widely used carbonaceous electrode materials, the Ge₃N₄ cells of the present invention yield capacities which, at about 450 mAh/g, exceed gravimetrically by more than 30% that of graphite, while volumetric capacity of about 2370 mAh/cm³ exceeds the 740 mAh/cm³ of graphite by an extraordinary 320%.

### BRIEF DESCRIPTION OF THE DRAWING

The present invention will be described with reference to the accompanying drawing of which:

FIG. 1 depicts schematically in cross-section elevation a typical rechargeable electrochemical energy storage cell embodying the present invention;

FIG. 2 presents a chart of comparative capacity stability of cells comprising various prior lithium-alloying negative electrode materials;

FIG. 3 depicts the characteristic voltage/capacity profile of a cycling cell comprising a lithium-germanium alloy electrode;

FIG. 4 depicts the plotted recycling capacity stability of the cell of FIG. 3;

FIG. 5 depicts the characteristic voltage/capacity profile of a cycling cell comprising a germanium nitride electrode embodiment of the present invention;

FIG. 6 depicts the plotted recycling capacity stability of the cell of FIG. 5;

FIG. 7 depicts the characteristic voltage/capacity profile of a cycling Li-ion cell embodiment of the present invention comprising a germanium nitride electrode; and

FIG. 8 is a representation of the open crystal structure of a germanium nitride electrode material comprising an embodiment of the present invention.

### DESCRIPTION OF THE INVENTION

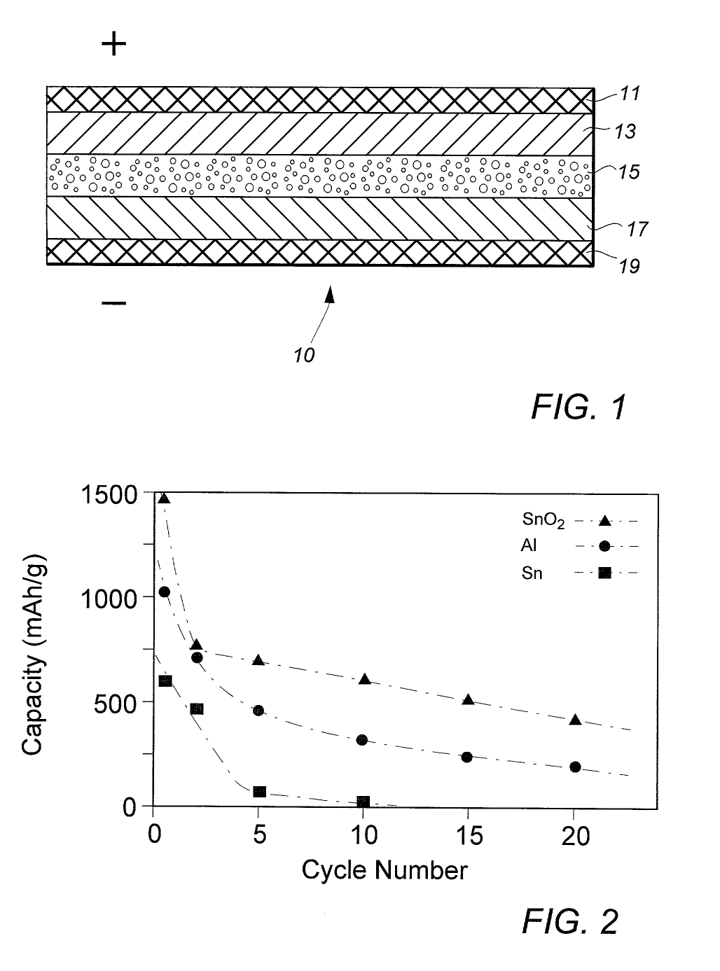

As shown in FIG. 1, a rechargeable battery cell in which the active electrode material of the present invention is employed is essentially of the same structure as the lithium battery cells currently in common use. In this respect, such a cell 10 comprises a positive electrode member 13, a negative electrode member 17 and an interposed electrically insulative, ion-conductive separator containing an electrolyte, typically in the form of a solution of a lithium salt in one or more non-aqueous solvents. Normally associated with the respective electrodes are electrically conductive current collectors 11, 19 which facilitate the application and withdrawal of cycling electrical current to and from the cell.

Further, the electrodes of the invention may be used in any of the common cell fabrication styles, e.g., the rigid metal casing compression style typified by the well-known “button” battery, or the semi-rigid or flexible film-encased laminated component polymer layer style of more recent development, such as is generally represented in FIG. 1 and more specifically described in U.S. Pat. No. 5,840,087. This latter style of laminated polymer battery cell was employed in the following examples, along with laboratory test cells of commonly used compressive Swagelok construction.

EXAMPLE I

In order to provide comparative data of the efficacy of previously employed inorganic electrode materials, a number of test cells were fabricated in the manner of the prior art comprising, as a laboratory expedient, a lithium metal foil electrode member and an opposing electrode member comprising a Li-alloying metal or metallic oxide, such as Sn, Al, or SnO₂ powder, dispersed in a polymeric binder layer. In such a primary test configuration, the greater reducing potential of the metallic lithium of course relegates that material to negative electrode member 17 while the complementary active material under examination comprises positive electrode member 13. The electrode members of each test were assembled in a Swagelok test cell with an intervening separator member 15 of borosilicate fiber saturated with a common lithium cell electrolyte, e.g., a 1.0 M solution of LiClO₄ in propylene carbonate. The stainless steel compressive plunger members of the Swagelok test cell functioned as current collectors 11, 19.

Each of the test cells was cycled at the rate of about 14 mA/g in a commercial automatic cycle-control and data-recording apparatus, e.g., a MacPile controller. The discharge capacity of each cell over a number of charge/discharge cycles is shown in FIG. 2. Each of these depicted data exemplifies the rapid and continuous decline in operating capacity exhibited by these prior negative cell materials, despite initial capacities often exceeding 1000 mAh/g.

EXAMPLE II

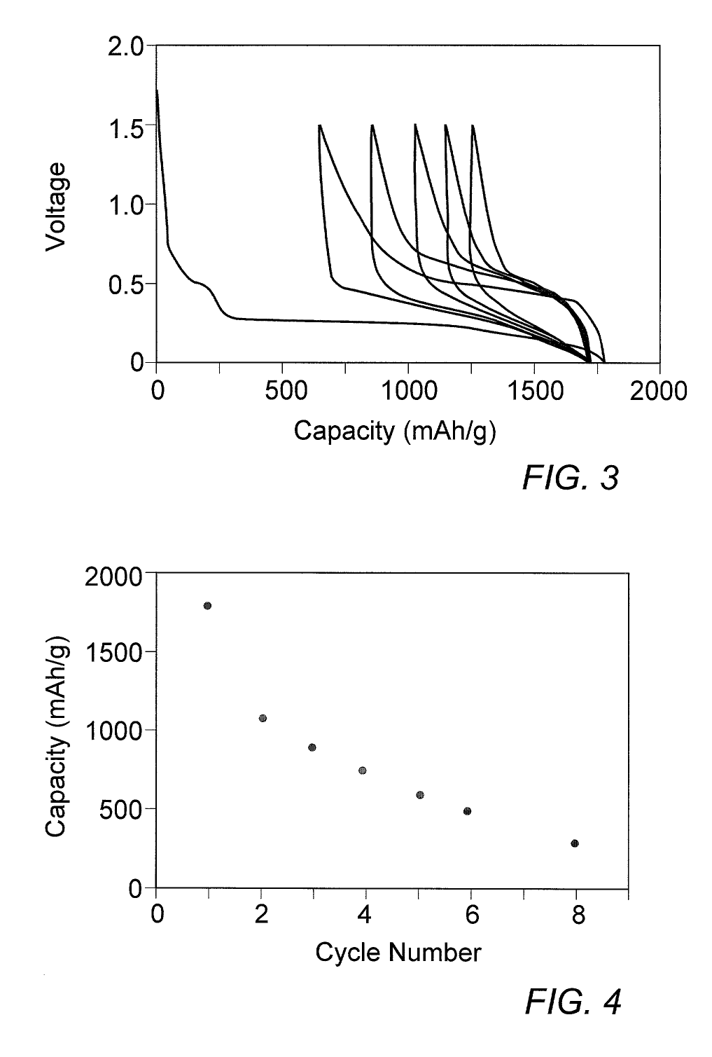

In the search for Li-alloying electrode materials with a satisfactory discharge capacity stability, a positive electrode 13 of germanium metal was assembled in a cell and tested in the foregoing manner. This cell exhibited a promising characteristic voltage/capacity cycling profile, as shown in FIG. 3, with an initial capacity of about 1800 mh/g and an operating voltage in the preferred range; however, as with other alloying electrode materials, the capacity of this cell deteriorated rapidly, as is apparent from these plotted data in FIG. 4.

EXAMPLE III

Further such investigations into alternative inorganic negative electrode compositions fortuitously happened upon the remarkable material of the present invention, Ge₃N₄. After initial indications of probable utility, a more optimally formulated electrode composition was prepared of 65 parts by weight of a commercial Ge₃N₄ powder (30-55 μm), 6.5 parts of Super-P conductive carbon, 10.5 parts of vinylidene fluoride: hexafluoropropylene (88:12) copolymer, and 18 parts of dibutyl phthalate (DBP) plasticizer. A coatable dispersion of the foregoing composition in acetone was cast and air-dried to a flexible film layer from which a 1 cm² electrode sample was cut. The sample was immersed in diethyl ether to extract the DBP plasticizer component, dried, and then assembled as a positive member 13 with a similarly sized negative electrode member 17 of lithium foil on a nickel support and a borosilicate glass fiber separator member 15 in the Swagelok test cell. A 1.0 M activating electrolyte solution of LiPF₆ in a 1:1 mixture of EC:DMC was added to the assembled members prior to sealing the cell.

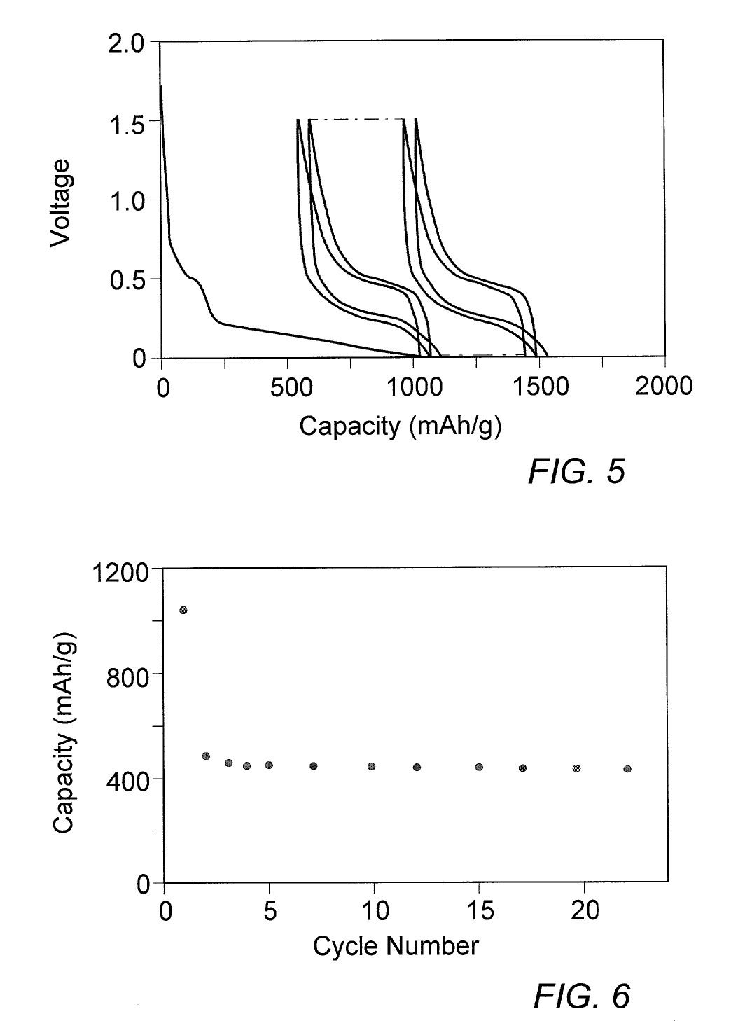

The test cell was cycled at a constant 14 mA/g and provided data for the voltage/capacity profile of FIG. 5 which shows, in comparison with known inorganic electrode materials, a remarkable early stabilization, as seen in FIG. 6, at a discharge capacity of about 450 mAh/g, representing a 35% increase over the typical, widely employed graphite electrode. Of still greater significance in the fabrication of energy storage cells for miniaturized utilization devices is the steady volumetric discharge capacity of about 2370 mAh/cm³, more than an order of magnitude greater than that of graphite, exhibited by the Ge₃N₄ electrode material of the present invention.

EXAMPLE IV

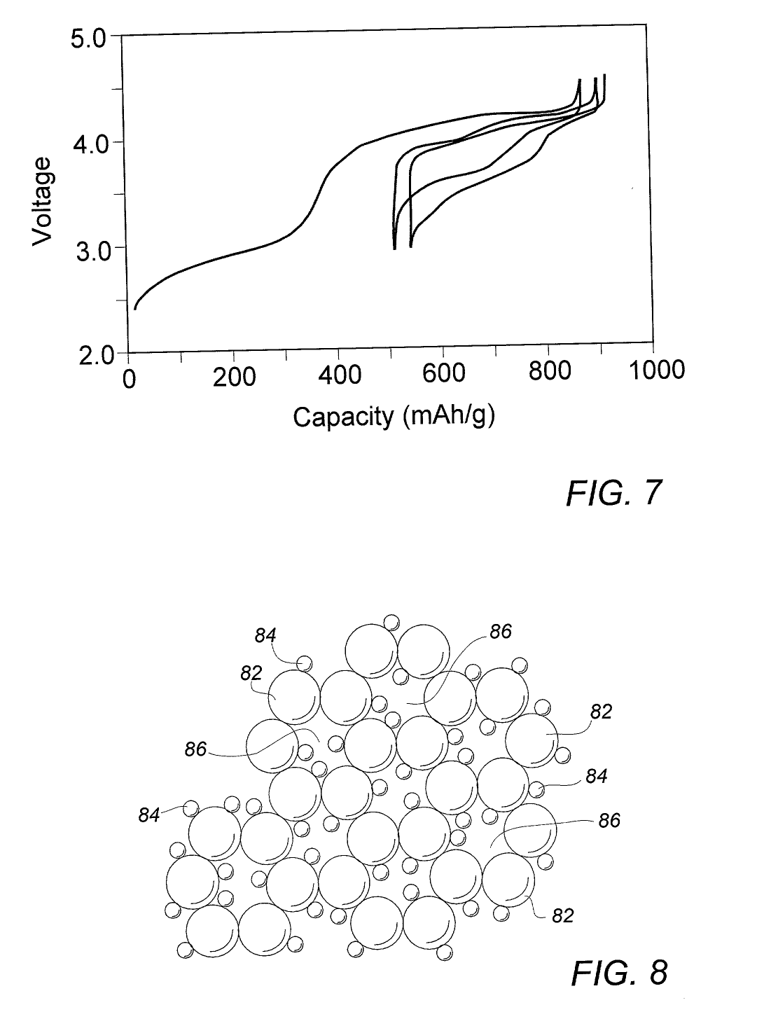

A Ge₃N₄ electrode layer material of the foregoing example was combined, as negative electrode member 17, with a similarly cast polymeric layer comprising, as the active material of positive electrode member 13, a spinel intercalation compound, Li₂Mn₂O₄, instead of the Ge₃N₄ to fabricate a rechargeable Li-ion battery cell. The thickness of the respective electrode layers, and thus the amount of active material in each electrode, was adjusted to provide a ratio of about 2:1 spinel compound. The resulting cell was activated with electrolyte and tested as in Example III to yield the characteristic voltage/capacity profile plot of FIG. 7. Use of such positive lithiated electrode materials of higher lithium content effectively resolves the irreversible capacity loss sometimes encountered during the initial charging cycle of Li-ion battery cells.

The Ge₃N₄ electrode material of the present invention was further investigated with a view toward determining the basis of the exceptionally high and stable capacity of lithium cells comprising this material. Indications of the source of this most desirable property arose from x-ray diffraction (XRD) studies of the crystal structure of Ge₃N₄ active electrode component during cell operation. Unlike previously employed metallic alloying and carbonaceous insertion electrode materials, e.g., the widely employed graphite electrode compositions, which suffer disruptive physical expansion as a result of lithium ion assimilation during cell recharging, the Ge₃N₄ material remarkably exhibits no such tendency. These XRD studies have revealed a unique structure in the metal nitride crystal, such as represented in FIG. 8, which apparently includes an open interlocking hexagonal arrangement of nitrogen atoms 82 which is stabilized by conjoined germanium atoms 84 to yield interstitial spaces 86 which may be readily occupied by migrating lithium ions during a cell charging cycle. These spaces appear to be about five times the size of lithium ions; therefore, the nitride crystal is immune from any significant expansive stresses during intercalation or other assimilation of numerous lithium ions, thereby providing high capacity which is stable against structural deterioration.

Utilization of the Ge₃N₄ electrode material of the present invention in Li-ion battery cell configurations with other previously accepted positive electrode compositions comprising, for example, such intercalation compounds as LiMn₂O₄, LiCoO₂, LiNiO₂, and the like, provides similarly impressive results and promises to improve dramatically the efficacy and economics of battery cells for the electronics industry.

It is anticipated that other embodiments and variations of the present invention will become readily apparent to the skilled artisan in the light, of the foregoing description and examples, and such embodiments and variations are intended to likewise be included within the scope of the invention as set out in the appended claims.

What is claimed is:

1. A rechargeable electrochemical energy storage system comprising a first electrode member of first polarity, a second electrode member of second polarity opposite said first polarity and a separator member providing an electrolyte interposed between said first and second electrode members, wherein
said first electrode member comprises a crystalline metallic nitride having a structure comprising an open interlocking hexagonal arrangement of nitrogen atoms.

2. An energy storage system according to claim 1 wherein said crystalline metallic nitride comprises germanium nitride.

3. An energy storage system according to claim 1 wherein said first electrode member comprises a negative active material consisting essentially of Ge₃N₄.

4. An energy storage system according to claim 3 wherein said second electrode member comprises a positive active material comprising a lithiated transition metal oxide.

5. An energy storage system according to claim 1, wherein said system comprises a lithium battery cell.

6. An energy storage system according to claim 1, wherein said system comprises a Li-ion battery cell.

7. A rechargeable lithium battery cell comprising a positive electrode member, a negative electrode member, and a separator member providing an electrolyte interposed between said positive and negative electrode members, wherein
said negative electrode member comprises a negative active material comprising germanium nitride.

8. A battery cell according to claim 7 wherein said negative active material consists essentially of Ge₃N₄.

9. A rechargeable electrochemical battery cell comprising a first electrode member comprising positive active electrode material, a second electrode member comprising negative active electrode material and, an electrically insulative and ion-conductive separator member providing an electrolyte interposed between said first and second electrode members, wherein
said negative electrode member comprises a crystalline metallic nitride having a structure comprising an open interlocking hexagonal arrangement of nitrogen atoms.

10. A battery cell according to claim 9 wherein said negative active electrode material comprises germanium nitride.

11. A battery cell according to claim 10 wherein said negative active electrode material consists essentially of Ge₃N₄.
